(19) United States
(12) Patent Application Publication
(10) Pub. No.: US 2005/0269401 A1
(43) Pub. Date: Dec. 8, 2005

(54) System and method for securing financial transactions

(75) Inventors: Thomas N. Spitzer, Portland, OR (US); Prabhakar Tadepalli, Bangalore (IN); Siva G. Narendra, Portland, OR (US)

Correspondence Address: LeMoine Patent Services, PLLC;c/o PortfolioIP, P.O. Box 52050, Minneapolis, MN, 55402, US

(73) Assignee: Tyfone, Inc.

(21) Appl. No.: 11/144,267

(22) Filed: Jun. 3, 2005

Related U.S. Application Data
(60) Provisional application No. 60/576,894, filed on Jun. 3, 2004.

(51) Int. Cl. G06K 5/00

(52) U.S. Cl. 235/380

(57) ABSTRACT

A financial transaction system utilizes multi-factor authentication to secure financial transactions.

### RELATED APPLICATIONS

Benefit is claimed under 35 U.S.C. 119(e) to U.S. Provisional Application Ser. No. 60/576,894, entitled “System and Method for Securing Financial Transactions” by Spitzer et al., filed Jun. 3, 2004, which is herein incorporated in its entirety by reference for all purposes.

### FIELD

The present invention relates generally to portable transaction devices, and more specifically to portable transaction devices having various security features.

### BACKGROUND

Instances of financial card fraud and identity theft have increased dramatically in recent years, particularly with the rapid increase of online and electronic transactions. Solutions of varying efficacy have been proposed to protect financial information and otherwise guard against fraud and theft. Firewalls protect computer systems against unauthorized access; however, they cannot be completely assured of the identities of individuals accessing the network. Various electronic devices may be employed to verify the identity of individuals; however, these devices often permit authentication information to be accessed. Some systems provide significantly improved security, but at the expense of requiring substantial changes to point-of-sale devices or other parts of the transactional infrastructure.

### BRIEF DESCRIPTION OF THE DRAWINGS

FIGS. 1 and 2 show transaction systems with multi-factor authentication;

FIG. 3 shows a block diagram of a programmable card;

FIG. 4 shows a block diagram of a secondary wireless device;

FIG. 5 shows a computer and base station;

FIG. 6 shows usage models for various embodiments of the present invention;

FIG. 7 shows an intelligent electronic device capable of printing checks;

FIGS. 8-10 show various methods for financial card transaction verification in accordance with various embodiments of the present invention;

FIG. 11 shows a flexible form factor for a programmable financial card;

FIG. 12 shows an exploded perspective view of the programmable financial card of FIG. 11; and

FIG. 13 shows usage models for a secondary wireless device in card-present transactions and card-not-present transactions.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present disclosure relates generally to use of a portable transaction device having various security features. The security features may be employed to particular advantage in financial transactions, so as to enhance security beyond that currently available in transactions conducted with financial cards, bank checks and existing computing devices. Traditionally, financial cards have information physically present on the front face and in the magnetic stripe. Similarly, bank account number, account holder's name, routing number and the address are present in the face of the checks. If a financial card or a checkbook is lost or stolen, or if the card is skimmed (an unauthorized swipe to gather card holder information stored on the stripe), the information is insecure and is available for use by anyone. Similar risks are present with computing devices and other electronic devices used in financial transactions.

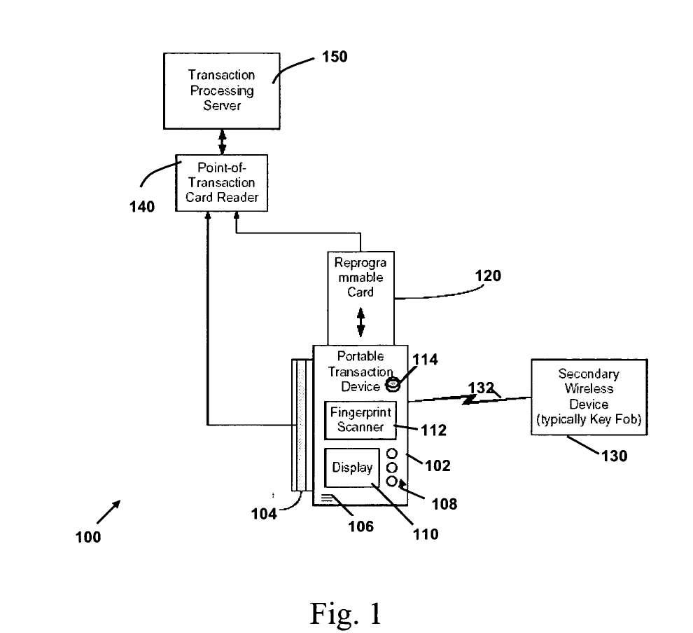

Accordingly, as shown in FIG. 1, a transaction system 100 with multi-factor authentication may be employed. As shown in this embodiment, the system 100 may include: a central transaction processing server 150; a point-of-sale transaction card reader 140; a portable transaction device 102 for use in credit/debit card type transactions; a key fob or other secondary wireless device 130 configured to wirelessly communicate with the portable transaction device 102; a reprogrammable card 120 that may be inserted into the portable transaction device 102 and reprogrammed with a one-time use transaction number or a reprogrammable electronic stripe 104 attached directly to the portable transaction device 102.

The portable transaction device 102 may include a camera (video and picture) component 114, a biometric (e.g., fingerprint) scanner 112, a display 110, a voice (microphone and speaker) component 106, and controls 108. The portable transaction device 102 may also include voice-activation and camera functionality. The secondary wireless device 130 may communicate wirelessly with the portable transaction device 102 using any type of wireless communications protocol. For example, the secondary wireless device 130 and the portable transaction device 102 may communicate using a Bluetooth type wireless link 132.

Where a one-time use transaction number is employed, the number may be generated by the card issuer or locally by the portable transaction device 102. Generation of the single-use number may be accomplished in one of several ways. For example, when an account is issued the card holder may get several pre-assigned surrogate numbers. The numbers will also have a pre-specified sequence. This sequence is known to the issuing bank and the user's portable transaction device 102. The issuing bank will authorize payments only based on the expected sequence of account numbers. If out-of-sequence account numbers are used, then the issuing bank will consider that transaction as a potential theft. The issuing bank can also use this feature to track the merchant involved in the potentially fraudulent transaction.

According to another example, a pre-assigned sequence can be reset to the original starting number on the list depending on user input or other triggers. In addition, the list of numbers can be downloaded via the mobile phone network on a regular basis. This can enhance security by minimizing the potential for repetitive number lists.

Regardless of the particular method, upon receipt of the surrogate card number, the merchant typically sends the surrogate card number to the card issuer for authorization/validation. Merchants do not need to install additional software to receive surrogate card numbers or to transmit them to card issuers. When the card issuer receives the account number, it is flagged as a single-use number and decoded to reveal the cardholder's standing account number. An authorization or denial is attached to the account number, which is recoded back to the temporary account number and sent to the merchant. Any attempt to reuse a surrogate card number outside the parameter results in denied authorization. In addition to or instead of these examples, other methods for generating one-time use numbers may be employed.

In conducting a transaction, the user, possessing both the secondary wireless device 130 and the portable transaction device 102, may press a control button 108 on the portable transaction device 102 requesting that the card 120 or electronic stripe 104 be readied with a new one-time use transaction number. The electronic stripe 104 may be selected by the user for use in swipe-type card readers, and the card 120 may be selected for either swipe-type card readers or insertion-type card readers, such as ATMs. It will be appreciated that the device 102 may be manufactured with only an electronic stripe, or only a card reader, rather than both. It will be further appreciated that the card 120 may include a reprogrammable magnetic stripe, a reprogrammable electronic stripe, or may be a so-called “smart” card with a reprogrammable internal memory, and the portable transaction device 102 may be configured to interface and reprogram one or more of these types of cards.

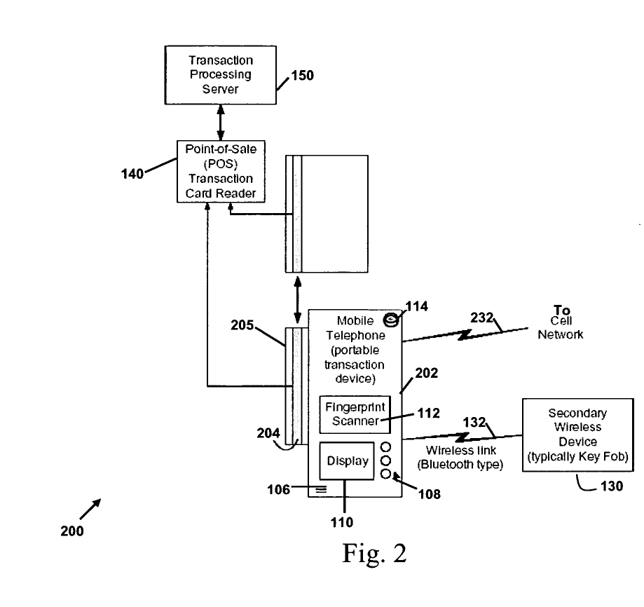

It should be appreciated that the portable transaction device 102 may be implemented in a variety of different configurations. For example, as described at length below and shown below in an alternate system depiction (FIG. 2), the portable transaction device may be implemented as, or in connection with, a mobile telephone.

FIG. 2 shows a transaction system with multi-factor authentication. Transaction system 200 includes transaction processing server 150, point-of-sale (POS) transaction card reader 140, mobile telephone 202, removable and reprogrammable card 205, and secondary wireless device 130. Mobile telephone 202 is an example of a portable transaction device, and any reference made herein to a portable transaction device is meant to include mobile telephones as well as other portable transaction device embodiments.

The mobile telephone 202 may include a camera (video and picture) component 114, a biometric (e.g., fingerprint) scanner 112, a display 110, a voice (microphone and speaker) component 106, and controls 108. The mobile telephone 202 may also include voice-activation and camera functionality. The secondary wireless device 130 may communicate wirelessly with the mobile telephone 202 using any type of wireless communications protocol. For example, the secondary wireless device 130 and the mobile telephone 202 may communicate using a Bluetooth type wireless link 132. Further, the mobile telephone may communicate with a cell network, shown by signal 232.

Removable and reprogrammable card 205 may be utilized in many ways. For example, removable and reprogrammable card 205 may be left in the mobile telephone 202 for use in swipe-type card readers, or may be removed from mobile telephone 202 for use with insertion-type card readers. Examples of insertion-type card readers include automatic teller machines (ATMs).

In the example of FIG. 2, the mobile phone 202 provides all the functionality of the previously-described portable transaction device 102 (FIG. 1). In addition, the ability of the mobile phone 202 to access a communications network (e.g., the cell phone network) may be used to provide additional functionality. For example, if the cell phone is lost, a call can be placed through the network to disable all financial card functions. If the key fob is lost, a new key fob can be mailed to the user and the configuration information can be updated automatically by placing a call through the cell phone network.

Regardless of the particular configuration, the system may be configured to eliminate or reduce fraudulent transactions by performing multiple authentications of each transaction, as follows. Possession of the portable transaction device provides a first factor of authentication. Second, the fingerprint of the user may be scanned and checked against a fingerprint stored in memory on the device. Third, at the time of the transaction, the wireless link to the secondary wireless device may be checked to verify that the secondary wireless device is communicating a proper device ID to the portable transaction device, thus indicating that the secondary wireless device is located within a predetermined distance of the portable transaction device. If these authentication steps are satisfied, the electronic stripe or card is reprogrammed with a one time use transaction number. In addition, the portable electronic device may store information pertaining to multiple different cards, and the user would be allowed to supply an input specifying which of the cards would be designated for use in the upcoming transaction.

Once the card is readied for use after authentication and any required user input, the user or a store clerk may swipe the electronic stripe through a swipe-type card reader, remove the card from the device and swipe it in a swipe-type card reader, or feed it into an insertion-type card reader, such as found on an ATM. As an additional authentication step, the one-time use transaction number may be checked by the transaction processing server for validity.

As described above, various embodiments of the present invention provide multi-factor authentication. For example, various embodiments of the invention may use two or three factor authentication for access control and information or identity theft prevention of financial card, bank check, electronic and computing devices. Two-factor authentication is defined as providing access based on validating whether the user has access to at least two verifiable pieces of information that are truthful and are available only to him/her. An example of two factor authentication is having access to a debit card and knowing the correct PIN number to complete a debit card transaction. Similarly, three-factor authentication is defined as providing access based on validating whether the user has access to at least three verifiable pieces of information that are truthful and are available only to him/her.

The following is an outline of various system elements that may be used in implemented various embodiments of the described systems and methods. It will be appreciated that no single element is essential to every possible exemplary embodiment.
1. Portable transaction device (e.g., portable telephone)
   A. Wireless interface configured to detect secondary wireless device when within predetermined distance (e.g. Bluetooth)
   B. Fingerprint scanner
   C. Memory storing fingerprint data of authorized user
   D. Display (optional)
   E. Controls for reprogramming card/stripe
   F. Card insertion slot
   G. Electronically reprogrammable stripe
   H. Camera functionality: when the portable transaction device is activated, a photograph of the user may be taken. The photograph may be send to the card issuer and/or displayed on the portable transaction device during use to provide additional security (e.g., a fourth authentication factor)
   I. Voice-activation functionality
2. Wireless secondary device (e.g. key fob)
   A. Wireless link to portable transaction device
3. Card
   A. Magnetically programmable stripe OR electronically programmable stripe, OR electronically programmable internal memory (so called smart card)
   B. Configured to be inserted into portable transaction device and programmed with a one-time use card number on a per-transaction basis
4. Point of Transaction Card Reader
5. Transaction Processing Server
6. Authentication factors (may be implemented in varying combinations) to determine if a pending transaction is fraudulent
   A. Wireless secondary device within predetermined range of portable transaction device
   B. Scanned fingerprint matches stored fingerprint
   C. Single-use transaction number written to card is valid

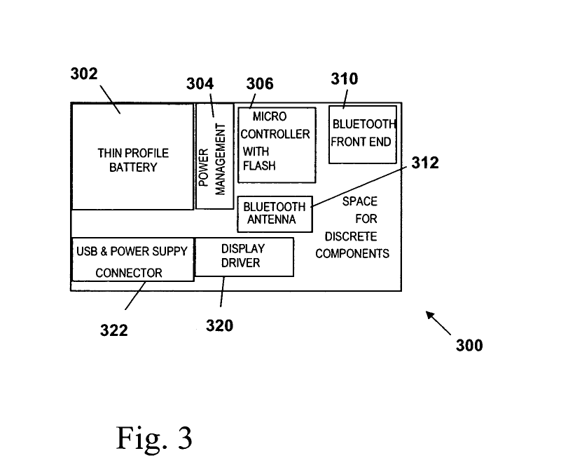

FIG. 3 shows a block diagram of a programmable card. Programmable card 300 may be utilized as removable and reprogrammable card 205 (FIG. 2). Programmable card 300 includes thin profile battery 302, power management circuitry 304, microcontroller with flash 306, Bluetooth front end 310, Bluetooth antenna 312, universal serial bus (USB) and power supply connector 322, and display driver 320.

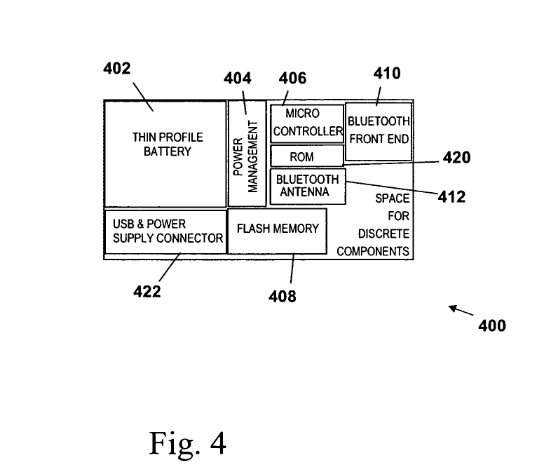

FIG. 4 shows a block diagram of a secondary wireless device. Secondary wireless device 400 may be utilized as secondary wireless device 130 (FIGS. 1, 2). Secondary wireless device 400 includes thin profile batttery 402, power management circuitry 404, microcontroller 406, read only memory (ROM) 420, FLASH memory 408, Bluetooth front end 410, Bluetooth antenna 412, and USB and power supply connector 422.

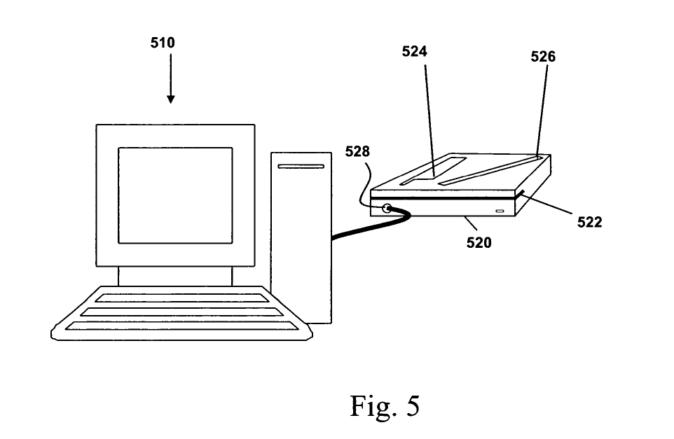

FIG. 5 shows a computer and base station. Computer 510 may be any type of computer or computing device capable of being operated by a user and being coupled to base station 520. For example, computer 510 may be a personal computer, a handheld computer, or the like. Computer 510 may include software to drive the base station and its components, and may also include graphical user interface (GUI) front end software for step-by-step user instructions for programming a reprogrammable card. As described above, programming a reprogrammable card may include selection of rolling numbers and associated maximum transaction amounts.

As shown in FIG. 5, base station 520 includes universal serial bus (USB) interface 528, card reader 522, secondary wireless device slot 526, and a reprogrammable card slot 524. Base station 520 may communicate with computer 510 over a cable coupled to USB interface 528. Although interface 528 is shown as a USB interface, this is not a limitation of the present invention. Any suitable interface may be used without departing from the scope of the present invention.

Base station 520 provides an interface between computer 510 and one or more other items. For example, in some embodiments, a reprogrammable card may be placed in slot 524 for communications with computer 510, or for programming by computer 510. Further, in some embodiments, a secondary wireless device may be placed in slot 536 for communications with computer 510, or for programming by computer 510. Also in some embodiments, base station 520 may be used for charging a reprogrammable card and secondary wireless device.

Base station 520 may also be used for reading standard magnetic cards to store information into a reprogrammable card. For example, a reprogrammable card may be placed in slot 524, and one or more standard magnetic cards may be swiped through card reader 522. Base station 520 may include circuitry to program a reprogrammable card directly from swiped magnetic cards, or may program a reprogrammable card under the control of computer 510.

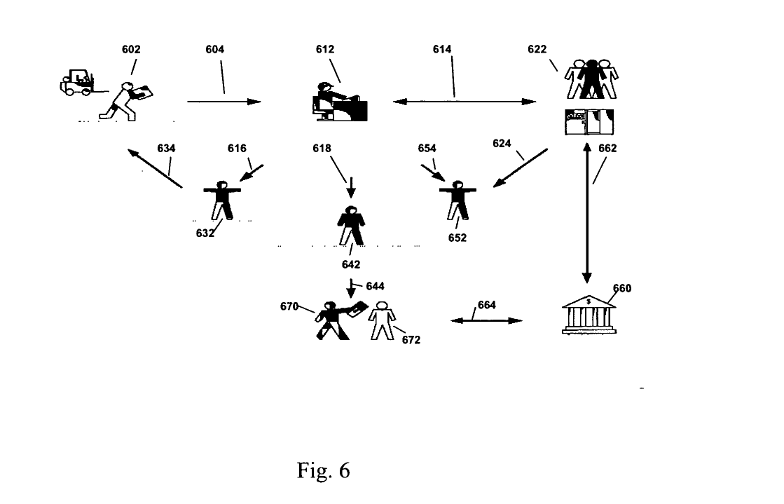

FIG. 6 shows usage models for various embodiments of the present invention. FIG. 6 shows user icons to represent users in various stages of use, and arrows to indicate actions. The various usage models are now described. At 602, an un-programmed reprogrammable card, a secondary wireless device, and a base station are shipped to a user. Software on CD-ROM and an optional travel kit may also be shipped to the user. At 604, the user 612 installs the software and connects the base station to a home personal computer (PC). The software is run to initiate programming, and the user scans a fingerprint into the reprogrammable card. The user plugs the reprogrammable card and the secondary wireless device into the base station.

At 614, the software communicates with a server 622 to activate the reprogrammable card and secondary wireless device. Server 622 may be held at a secure location separate from the user and from a card issuing bank 660. For example, server 622 may be held by a company that provides reprogrammable cards and secondary wireless devices. Further, information may be stored on the server 622 for retrieval in case of loss of the reprogrammable card or secondary wireless device. The user 612 may then scan one credit card at a time into the base station. This may be repeated any number of times. The user 612 is shown at a PC performing the actions just described.

At 618, the user 642 has completed the setup, and has a reprogrammable card available for use. The user 642 carries both the reprogrammable card and the secondary wireless device. It is best to keep the secondary wireless card separate from the reprogrammable card. The secondary wireless device never has to be accessed by user 642 to initiate a transaction. At the end of the day, the user 642 plugs the reprogrammable card and the secondary wireless device into the base station for charging and account summary.

At 644, user 670 initiates a transaction with merchant 672. To initiate the transaction, user 670 activates the reprogrammable card using a fingerprint scan and selects the credit card to use. The reprogrammable card authenticates only in the presence of the appropriate secondary wireless device. Information programmed on the reprogrammable card's electronic stripe will get erased automatically after a predetermined timeout. For example, the information may get erased after five minutes. To prevent multiple swipes, the information in the reprogrammable card may be erased after one swipe. An alternative is to provide a rolling account number that the credit card company can map to the actual account number. The account number may then roll to a new number for each fingerprint scan.

If a user 652 loses one of the reprogrammable card or secondary wireless device, shown by 654, the company will mail a preprogrammed reprogrammable card or secondary wireless device to the user 652 at 624. If a user 632 loses both the reprogrammable card and secondary wireless device, shown by 616, the company will help deactivate all user credit card accounts and start the process again at 634.

As described above, reprogrammable cards may take any suitable form. For example, reprogrammable cards may be magnetic stripe cards, electronically programmable cards, smart cards, or any combination. Various embodiments are now described under headings relating to magnetic cards, electrically programmable cards, and smart cards. It should be noted that nothing in these embodiments should be considered essential.

Magnetic Stripe Cards

Embodiments that include magnetic stripe cards are now described with reference to FIGS. 1-6. Various embodiments of the present invention include: (i) an intelligent (memory, computational power) electronic device that has magnetic stripe reading/writing capability, and a wireless link such as Bluetooth; (ii) a fingerprint scanner on the intelligent electronic device; (iii) electronic device such as a key that has memory and wireless connection such as Bluetooth; and (iii) an empty generic three track magnetic stripe card that can be programmed by the intelligent electronic device on a per transaction basis. For example, FIGS. 1 and 2 show portable transaction devices 102 and 202 that may be used as intelligent electronic devices. Further, portable transaction devices 102 and 202 are shown having wireless links and fingerprint scanners. Portable transaction device 202 is shown having a magnetic stripe reader/writer to program reprogrammable card 205.

The use of an intelligent electronic device with a fingerprint scanner or the use of an intelligent electronic device and the key (secondary wireless device) constitutes a two-factor authentication solution while the use of all three (intelligent electronic device with the fingerprint scanner and the key) constitutes a three-factor authentication solution.

The user first installs interface software in the intelligent electronic device. Using the installed software the user scans his/her portfolio of standard financial cards using the integrated magnetic stripe card reader. The user may also enter information necessary for financial card transactions that may not be present in the magnetic stripe such as a security code. The user also scans a fingerprint to associate the cards with the user. The financial card information is stored in the intelligent electronic device in encrypted form. The decryption code for the information stored in the intelligent electronic device may be stored in the key. Each intelligent electronic device may have an associated key that is unique. Once all the relevant information is stored in the intelligent electronic device, the user may slide the generic card into the integrated magnetic stripe reader/writer.

When the user is ready to use a financial card for a transaction s/he logs into the intelligent electronic device using the fingerprint scanning device or by entering a password. In the two-factor solution, the card user can proceed with initiating the transaction. In the case where the user opts for a three-factor solution, the intelligent electronic device will let the login occur only if it is able to establish a wireless link with its associated key. The user then selects the type of card to use. After log in using either approach, the intelligent electronic device receives the decryption code from the key to access the information about the selected card, if key based authentication is used. If fingerprint scan based authentication is used for two-factor then the decryption code is stored in the intelligent electronic device itself, which will be provided after the authentication. The user then pulls out the generic card, during which the card is programmed by the magnetic writer. At this point the intelligent electronic device deletes the decryption key information that it received from the key. Once programmed, the generic card can be used like any other magnetic stripe financial card. Once the transaction is completed the user inserts the card back into the intelligent electronic device during which the information stored in the magnetic stripe is erased.

Further embodiments may be generated by combining various feature of magnetic card embodiments with electronically programmable embodiments and smart card embodiments, described below. The use of magnetic cards as reprogrammable cards may obviate the need for a power supply in the card, and provides a mechanism to use traditional three track magnetic stripe cards and hence does not require development of a card that has an alternate programming medium.

Note that the need for having access to the intelligent electronic device along with fingerprint scanning and the presence of a key provides a three-factor authentication. The same can be implemented without the key in which case the security of the information stored in the intelligent electronic device may be achieved with two-factor authentication through fingerprint scanning. The key can also be replaced with a PIN input+fingerprint scanning; however, without the key the decryption code is physically stored in the same device as that of the information. A key along with the intelligent electronic device can be used as two-factor authentication.

Electronically Programmed Cards

Embodiments that include electronically programmable cards are now described with reference to FIGS. 1-6. Various embodiments of the present invention include: (i) a base station having the ability to scan a user's card information; (ii) an electronic card that has an electronically programmable region that has identical dimensions as that of a magnetic stripe (henceforth referred to as the electronic stripe), a wireless link such as Bluetooth and a fingerprint scanner; (iii) an electronic device such as a key that has memory and a wireless link such as Bluetooth. For example, FIGS. 1 and 2 show portable transaction devices 102 and 202 that may be used as intelligent electronic devices. Further, stripe 104 (FIG. 1) may be a reprogrammable electronic stripe, and stripe 204 (FIG. 2) may be a reprogrammable electronic stripe. Note that the electronic programming may be done using electric currents. The direction of current travel will change the magnetic field and hence can be used to code for a digital “1” or a digital “0”. This information can then be read by a traditional magnetic stripe reader present in point-of-sale.

The electronic card may come preprogrammed with software that will allow users to input card information or the users may first install interface software in the intelligent electronic device or in the base station. Using the installed software the user will then enter standard financial card information. An optional card reader can be used to read most of the information present in a financial card. The financial card information will be stored in the intelligent electronic device in encrypted form. The decryption code for the information stored in the intelligent electronic device will be stored in the key. Each intelligent electronic device will have an associated key that is unique.

When the user is ready to use a financial card for a transaction s/he logs into the intelligent electronic device using a fingerprint scanning device or by entering a password. In the two-factor solution, the card user can proceed with initiating the transaction. In the case where the user opts for a three-factor solution, the intelligent electronic device will let the login occur only if it is able to establish a wireless link with its associated key. The user then selects the card to use through a card selection button on the face of the intelligent electronic device. The intelligent electronic device receives the decryption code from the key to access the information about the selected card. The intelligent electronic device programs the electronic stripe. At this point the intelligent electronic device deletes the decryption key information that it received from the key. Once programmed the intelligent electronic device can be used like any other magnetic stripe financial card. Once the transaction is completed, the intelligent electronic device erases the information stored in the electronic stripe. The electronic stripe can be programmed to time out after a certain length of time or after a specified number of swipes.

In some embodiments, the key may store all critical information from the intelligent electronic device as backup in encrypted format. The decryption code for information stored in the key may be present in its associated intelligent electronic device. Also in some embodiments, an intelligent electronic device may include software having the ability for the intelligent electronic device to either limit to one swipe after programming or record how many times a card was swiped between magnetic stripe programming and erasing. In further embodiments, the intelligent electronic device may include software and/or voice recognition that tracks the expenses based on user input every time the card is used or when the user makes any expense transaction to provide categorized expense summary. In further embodiments, the intelligent electronic device may include the ability to communicate to the point-of-sale the amount entered by the user for transaction—this however will require change to the point-of-sale. In still further embodiments, the intelligent electronic device may include the ability to generate one account number from a set of account numbers. These numbers will be generated in a predetermined sequence (or one time use numbers) that will expire at the end of every transaction to eliminate card cloning and counterfeiting operations. In some embodiments, this may be achieved by either using the 19 digit PAN Field and/or Discretionary Data character fields allocated in the magnetic stripe standards. For example, the way the variable number (required for off-line transactions) would work is that a card holder may be assigned let us say 100 account numbers. The account numbers will revolve in a pre-determined order. The issuing bank will know what order will be used and so will the intelligent electronic device. For each authentication the intelligent electronic device will activate one number in the pre-determined order. The variable number also applies for on-line transactions and can either replace or work with the one time use numbers.

In some embodiments, the programmed magnetic stripe may be detached from the main unit for use in transactions where the card is swallowed in whole to complete the transaction (such as in an ATM machine or at a gasoline pump). Also in some embodiments, a fixed base station may be connected to a desktop PC or a standalone base station and can be used for charging the intelligent electronic device and key. The base station may also be used to retrieve financial card information for the desktop PC from the intelligent electronic device for electronic transactions. The transaction will occur only if both the intelligent electronic device and key are present. The fixed base station may also be used to include the optional magnetic card reader to initially download the information into the intelligent electronic device. In some embodiments, an organic light emitting diode (LED) display and flexible printed circuit board (PCB) may be used to design an intelligent electronic device that has the form factor and mechanical flexibility of a plastic card so that it can be carried inside a wallet. The intelligent electronic device may also act as an agent that holds other secure information such as user ID and password for access by the user after two or three factor authentications. Further, an intelligent electronic device that is enabled with wireless may be used to show on-demand advertisement and coupons on its display. The information displayed can depend on the card holder's usage pattern, if available.

For card-not-present on-line transactions, the mode of operation may be one of the following: (a) base station will verify the presence of the intelligent electronic device along with two or three factor authentication, explained above, or (b) if random or one-time use numbers are used, then with two or three factor authentication the intelligent electronic device will provide the correct number to use for card-not-present transactions similar to card present transactions.

In electronically programmable embodiments, the user does not have to deal with a third component, the generic card, unlike the magnetic card options described above. Further, the erasing of the information stored in the electronic stripe may be automatic, whereas in the magnetic card embodiments, erasing may depend on the user sliding the generic card back into the intelligent electronic device.

Note that the need for having access to the intelligent electronic device along with fingerprint scanning and the presence of the key provides a three-factor authentication. The same can be implemented without the key in which case the security of the information stored in the intelligent electronic device is achieved with two-factor authentication through fingerprint scanning. The key can also be replaced with a PIN input+fingerprint scanning to result in three-factor authentication. However, without the key the decryption code is physically stored in the same device as that of the information and therefore susceptible to theft by hacking. The key along with the intelligent electronic device may be used as two-factor authentication.

Although the various embodiments of the present invention are described above using an intelligent electronic device and key, other devices may be utilized. For example, an intelligent electronic device may be a self powered smart card device that includes a display, fingerprint reader, and Bluetooth. Further, PIN entry or other biometric authentication can be used instead of fingerprint authentication.

Smart Cards

Embodiments that include smart cards are now described with reference to FIGS. 1-6. Various embodiments of the present invention include: (i) an electronic device such as a personal digital assistant or an intelligent electronic device with smart card interface and wireless link such as Bluetooth; (ii) an electronic device such as a key that has memory and wireless link such as Bluetooth; (iii) the ability to generate predefined card numbers at random that will expire at the end of every transaction to eliminate card cloning and counterfeiting operations; and (iv) an empty generic smart card that can be programmed by the intelligent electronic device. The assumption here is that the point-of-sale uses smart cards.

The usage model is similar to that described above with reference to magnetic stripe cards, except the Intelligent Electronic Device programs the smart card instead of the magnetic stripe card.

In some embodiments, the intelligent electronic device and the smart card may be integrated into one device. This will result in a device similar to devices described above with reference to electronically programmed cards, except it is to be used for smart card point-of-sale.

Further, in some embodiments, a standalone smart card may be utilized without the intelligent electronic device. Each smart card will have an associated key. The smart card point-of-sale will verify if the associated key is present before approving the transaction. One feature of these embodiments is that the smart card is not programmable to act as one of several cards and will require change in the point-of-sale.

Although the various embodiments of the present invention are described above using an intelligent electronic device and key, other devices may be utilized. Further, PIN entry or other biometric authentication can be used instead of fingerprint authentication.

Various embodiments described thus far include “programmable” financial cards, where “programmable” refers to the fact that the information for the card's stripe is programmable to represent one of several cards held by the card holder. Embodiments are now described that are applicable to authentication for bank checks.

Authentication for Bank Checks

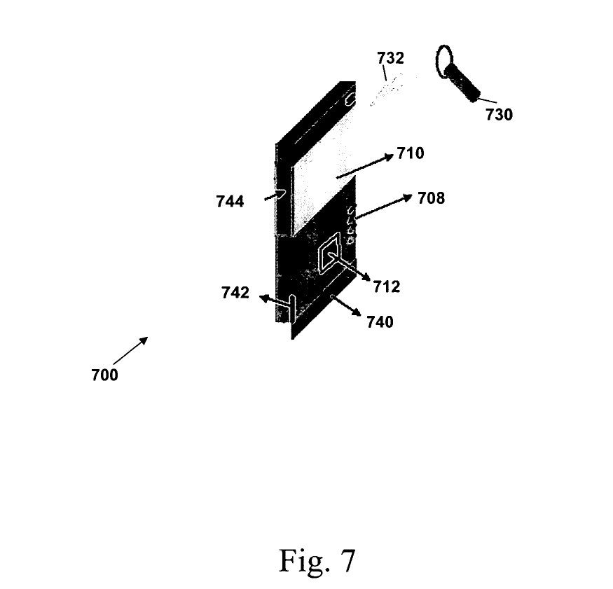

FIG. 7 shows an intelligent electronic device capable of printing checks. Intelligent electronic device 700 includes storage 744 for “blank” paper checks without account information, a wireless interface to support a wireless link 732 such as Bluetooth, a fingerprint scanner 712, a display screen 710, account selection and function buttons 708, and a miniature printer 742 to print checks. Also shown in FIG. 7 is a key 730 that has memory and a wireless link such as Bluetooth.

The intelligent electronic device 700 will be preprogrammed with relevant account (or accounts) information including account holder name, mailing address, account number, and bank routing number. When the user is ready to use the check book s/he will power up the intelligent electronic device. The device will authenticate the user by verifying the presence of the key and/or fingerprint ID. Once authenticated, the user will pick the account of choice and optionally enter memo along with the transaction amount information. The printer then will print the account and transaction information on the blank paper check to produce a printed check 740. Any features discussed above with reference to programmable card embodiments may utilized with intelligent electronic device 700 without departing from the scope of the present invention. Further, PIN entry or other biometric authentication can be used instead of fingerprint authentication.

Financial Card Transaction Verification

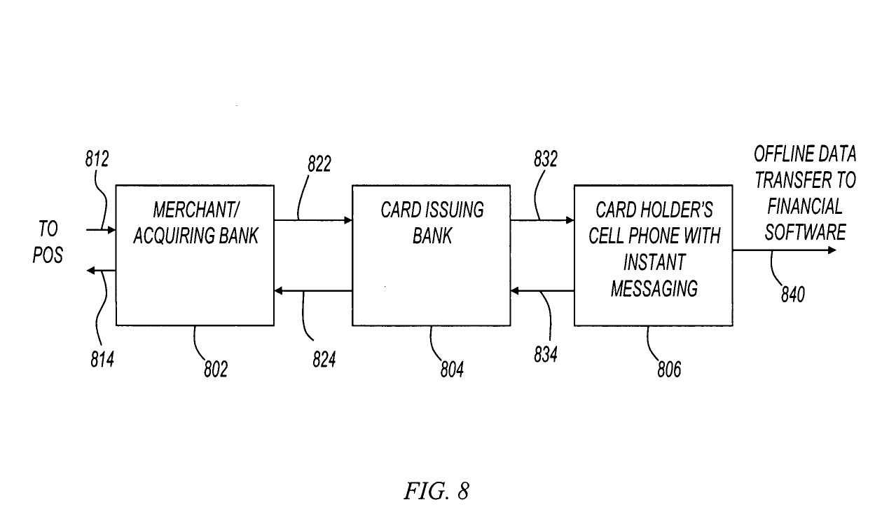

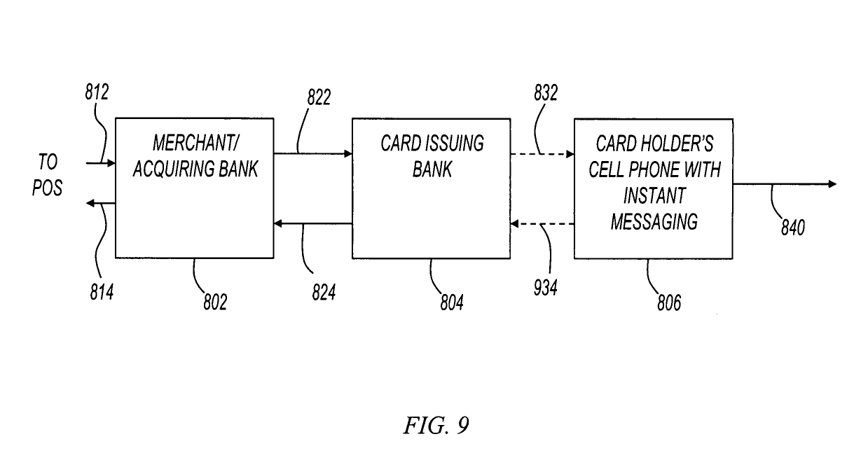

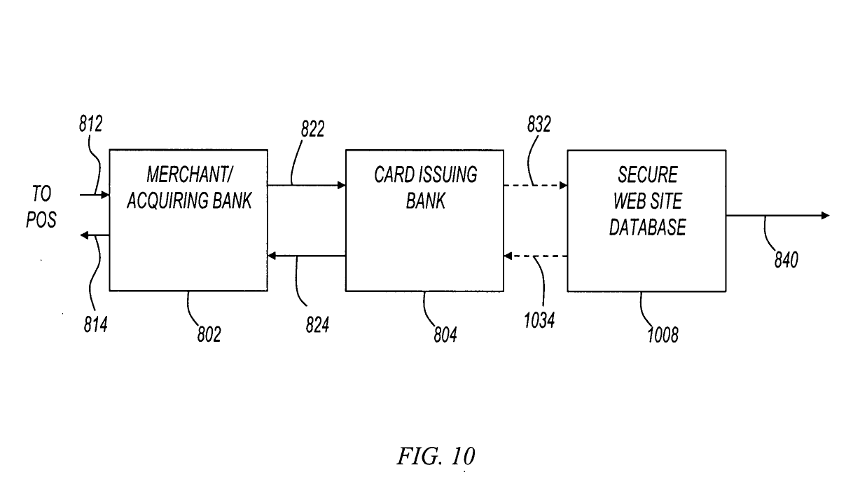

FIGS. 8-10 show various methods for financial card transaction verification in accordance with various embodiments of the present invention. FIG. 8 shows an example of “real time push verification,” FIG. 9 shows an example of “offline push verification,” and FIG. 10 shows an example of “offline pull verification.” The embodiments represented by FIGS. 8-10 are applicable for all programmable financial card embodiments described herein and for all other standard cards.

When a transaction is initiated from the point-of-sale, credit card and transaction information is transferred to an acquirer 802 and a card issuing bank 804. These transfers are shown at 812 and 822 in FIGS. 8-10. The card issuing bank 804 transfers an approval or denial of the transaction to the acquirer 802 and ultimately to the point-of-sale. The transfers are shown at 824 and 814 in FIGS. 8-10. The acquirer 802 typically pays the merchant after verification. The card issuing bank 804 then pays the acquirer 802.

In various embodiments of the invention, an additional step is added either during information processing at the acquirer or at the card issuing bank. This additional step involves instant messaging to the card holder's phone/email with the necessary transaction details, which then when approved by the card holder is recorded to be a legitimate transaction. The phone 806 can be a mobile phone running special software that indicates to the user that a new transaction has arrived for approval. If the approval is not completed within a prescribed time the transaction is marked as a possible suspect and further defensive actions can be taken. The transaction records on the mobile device 806 can be downloaded onto PC financial software for record keeping. This transfer is shown at 840. Access to mobile device instant messaging can be restricted via PIN entry, voice recognition, or other biometric authentication such as fingerprint.

FIG. 8 shows a real time push verification where the issuing bank 804 sends a real time message 832 to the mobile device 806 and waits for approval or denial at 834 before approving the transaction at 824. FIG. 9 shows an offline push verification where the issuing bank 804 sends a message 832, but does not wait for real time approval. Instead, a user may provide later notification of approval or denial at 934, and if necessary, the issuing bank 804 may take defensive action.

In other embodiments, instead of the information being pushed via automated mobile phone instant message, it can be an information pull based implementation, such as that shown in FIG. 10. In information pull implementations, the transaction details are logged on a secure web site 1008 where the user visits periodically to approve the transactions at 1034.

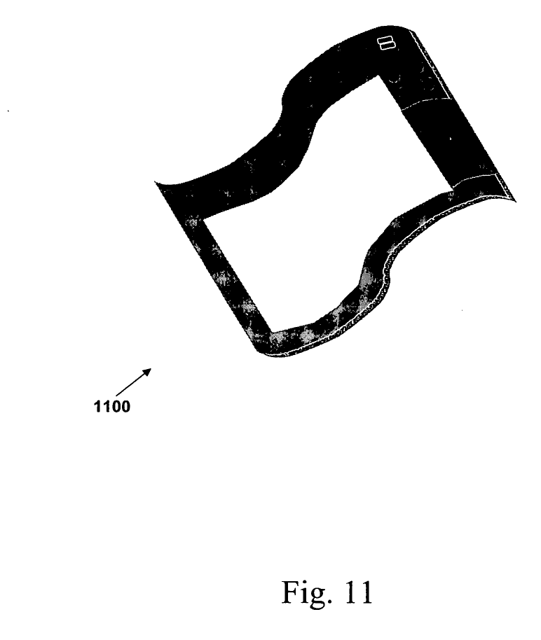

FIG. 11 show a flexible form factor for a programmable financial card. Programmable financial card 1100 has a flexible printed circuit board (PCB) that may include embedded integrated circuit components such as memory, processing, display driver, and wireless front end. In addition, programmable financial card 1100 may include a fingerprint reader, input buttons, organic LED display, and flexible battery power.

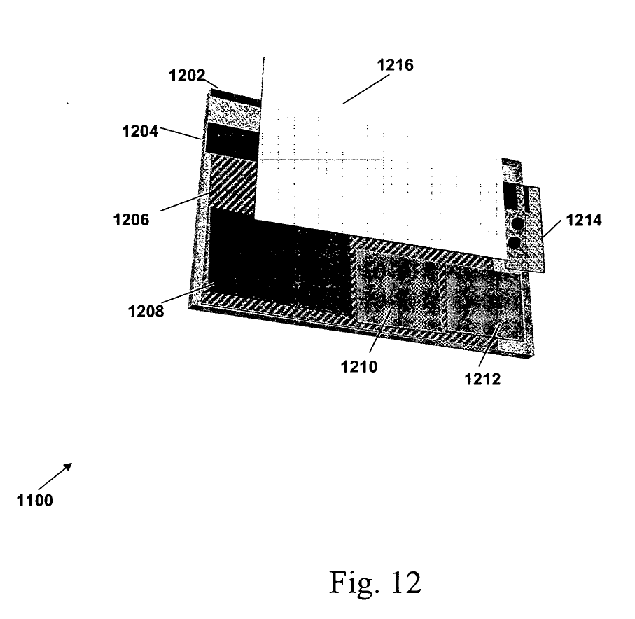

FIG. 12 shows a perspective exploded view of the programmable financial card of FIG. 11. Programmable financial card 1100 includes flexible PCB 1202, programmable stripe 1204, organic LED display 1216, and fingerprint input device 1214. Flexible PCB 1202 includes flexible battery 1208, battery charging by contactless coupling 1206, memory, processing, and display driver integrated circuits 1210, and wireless front end integrated circuit and antenna 1212.

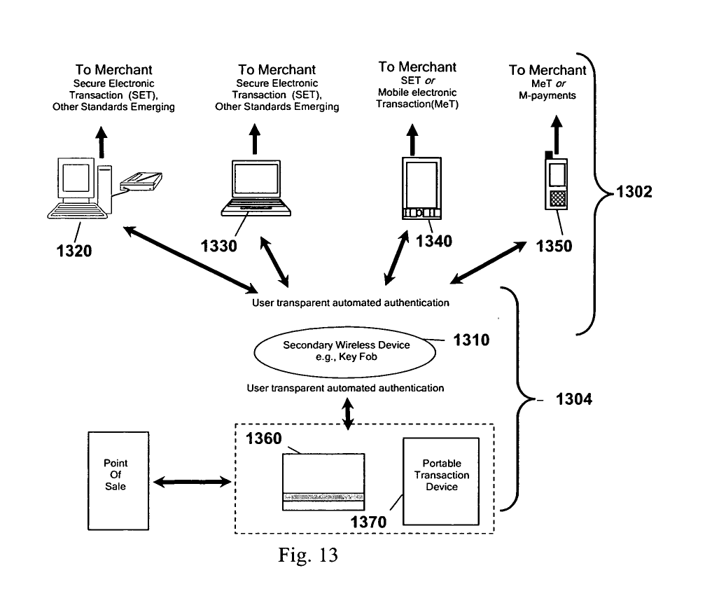

FIG. 13 shows usage models for a secondary wireless device in card-present transactions and card-not-present transactions. Usage models for card-not-present transactions are show in the top portion of FIG. 13, shown generally at 1302. In these embodiments, secondary wireless device 1310 communicates with various types of electronic devices that in turn communicate with point-of-sale terminals or merchants without a reprogrammable card present. For example, secondary wireless device 1310 may provide user transparent automated authentication with a home computer and base station 1320, laptop computer 1330, personal digital assistant (PDA) 1340, or cellular telephone 1350. These devices may then in turn communicate with merchants using one or more secure protocols such as: Secure Electronic Transaction (SET), Mobile electronic Transaction (MeT); M-payments; or other emerging standards.

Usage models for card-present transactions are show in the bottom portion of FIG. 13, shown generally at 1304. In these embodiments, secondary wireless device 1310 provides user transparent automated authentication with one or more of a reprogrammable card 1360 and portable transaction device 1370. Reprogrammable card 1360 may then communicate with point-of-sale terminals or merchants.

Multi-factor authentication may be utilized in both card-present and card-not-present transactions. For example, two factor or three factor authentication may be provided as described above with reference to FIGS. 1-6.

The following numbered paragraphs provide further disclosure of the systems and methods of the present description:

1. A financial transaction authentication system, including a mobile telephone (or handheld computer or other portable electronic device) having a biometric scanner and a transaction stripe that may be operatively engaged with a point-of-sale stripe reader, where the financial transaction authentication system is configured to combine biometric information with one or more additional authentication factors to secure financial transactions.

2. The system of paragraph 1, where the stripe is attached to the mobile telephone.

3. The system of paragraph 1, where the stripe is provided on a separate structure (e.g., a structure shaped and sized like a traditional financial card) that may be selectively inserted into and removed from the mobile telephone.

4. The system of paragraph 1, further comprising software configured to control financial transaction communication between the mobile telephone and various external systems involved in financial transaction, and configured to control communications between the mobile telephone and access controls implemented in buildings, cars etc.

5. The system of paragraph 1, further comprising software configured to implement and apply one-time use numbers on to the transaction stripe, wherein this may include local generation of the one-time use numbers or download of one-time use numbers via a mobile telephone network.

6. The system of paragraph 1, where the information is encoded onto the transaction stripe via electrical voltage pulses that generate magnetic fields to mimic magnetic stripe tracks in standard financial transaction cards. The sequence of pulses of time duration T and 2T may be used to code for 1 and 0. Since the pulse train is not stored magnetically the stripe length can be much smaller than that of a standard card. The card substrate can thus be much smaller than a traditional financial card. The card may include the transaction stripe, optional memory and optional energy storage to support complete detaching from the mobile telephone. The detachable card may also include wireless capability to communicate to the mobile telephone.

7. The system of paragraph 1, where in multi-factor authentication, biometric data (e.g., fingerprint) is used to access the mobile phone device and PIN entry is required to access account information.

8. The system of paragraph 1, further comprising a secondary wireless device, such as a key fob, that is used to provide an additional authentication factor, namely that the mobile telephone will not allow access to the financial card account information unless the secondary wireless device is in the vicinity. Wireless key can be implemented via bluetooth protocol as an example.

9. The system of paragraph 1, where the mobile telephone is employed as a wireless authentication key for two factor authentication in accessing other electronic systems such as laptops, PCs, cars etc.

10. The system of paragraph 1, where the mobile telephone is used for card consolidation, in that information for multiple accounts is stored within a memory in the mobile telephone, and where the user may select a particular account and after proper authentication, the account information for the selected account is applied to the transaction stripe.

11. The system of paragraph 1, where since the system may be configured to require two or more factor authentication for gaining access to account information, the system may be employed for secure card present and card not present transactions. Also, since the one-time use number generation is integrated into the mobile telephone, card present or card not present solutions can take advantage of this security feature.

12. The system of paragraph 1, where since the information on the electronic stripe is not coded in physical locations on the magnetic stripe more bits can be conveyed to the POS between the start and the stop sentinels. These additional bits can be used to have unique ID independent of any account information. This will ensure that even if account information is stolen without this unique ID in the stripe the transaction will not be valid. So a cloned card based on known account information will not make the transaction valid without this unique ID.

13. The system of paragraph 1, where since the mobile telephone device is connected to a mobile phone network, the account holder can set a per-transaction amount limit and if a transaction exceeds that limit the user will receive a secure SMS message (or a message via any other mobile network-based messaging service) requesting validation of the transaction; the transaction will be authenticated only after the user replies the SMS with an ‘overlimit’ password; the password will be independent of other passwords. Note that the per-transaction limit could be zero, which will require secure SMS authentication every transaction; also, if the mobile phone is not in a cell then the financial card issuing bank will note it as a ‘risky’ transaction and take appropriate action, such as invalidate the account for future transaction.

14. The system of paragraph 1, where since the mobile telephone device is connected to the mobile phone network, the account activation may happen via the mobile network after 2- or 3-factor authentication. Authentication may also happen via the mobile phone network; for example, a user will have to make a phone call and the system will verify the user's voice; once the voiceprint is verified, the mobile network will be used to download the financial card information onto the mobile telephone device.

15. The system of paragraph 1, where the mobile telephone device will also use the voice recording component in the mobile phones to record user voice keywords. The keywords will include the type of transaction and the amount of transaction. The keywords can then be downloaded into a PC with voice recognition for automated data entry into software such as Microsoft Money or Quicken. The mobile telephone device can have two directional microphones, one for recording background noise and one for recording voice and background noise. This will improve voice recognition by canceling out background noise.

16. The system of paragraph 1, where the mobile phone network can also be used to upload account summary automatically from the card issuing bank. This can then be downloaded into a PC. All connections to the PC will be via an optional base station. The base station will also be used to charge the phone.

17. The system of paragraph 1, where the mobile phone network can also be used to update the cell phone service provider of the financial transaction details. This can be used to consolidate the mobile phone bill with the credit card transaction bill.

18. The system of paragraph 1, where since the mobile telephone device is connected to the mobile phone network, if the device is stolen the mobile phone network can be used to call the phone to delete all account information. Also, the network can be used to track a delinquent account holder.

19. The system of paragraph 1, where since the mobile telephone device is connected to the mobile phone network, gift cards and other stored value cards can be directly transmitted to a recipient if his/her telephone number is known.

20. The system of paragraph 1, where the mobile phone network can be used to upload user-specific ads/coupons into the mobile telephone device. This can also involve using Bluetooth or Infrared network to upload user specific ads/coupons.

21. The system of paragraph 1, where messages sent via the mobile phone network to and from the mobile telephone will be encrypted. Each mobile telephone device will have a unique private and public key which will be used for sending secure information.

22. The system of paragraph 1, where since the mobile telephone device provides secure storage of information, it can be extended to store not such financial data but also other user information such as login IDs and passwords, account numbers for building access, user ID for access to cars, etc.

23. The system of paragraph 1, where the portable electronic device is configured to take photographs, and where a photograph of a user is taken during initial activation, and where such photograph is later employed to increase the security of a financial transaction (e.g., by providing an additional authentication factor).

24. The system of paragraph 1, where the portable electronic device is voice-activated.

25. The system of paragraph 1, where the transaction stripe is magnetically encoded via a magnetic head of the portable electronic device.

26. The system of paragraph 1, where the system is implemented using open technologies and specifications, such as ECML (electronic commerce modeling language).

27. The system of paragraph 1, where communications are secured via secure protocols such as TLS and SSL.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A portable transaction device having a biometric scanner and a transaction stripe that may be operatively engaged with a point-of-sale stripe reader, where the portable transaction device is configured to combine biometric information with one or more additional authentication factors to secure financial transactions.

2. The portable transaction device of claim 1 wherein the transaction stripe may be selectively inserted into and removed from the portable transaction device.

3. The portable transaction device of claim 1 further comprising a wireless interface to communicate with a secondary wireless device for an additional authentication factor.

4. The portable transaction device of claim 1 further comprising controls to allow a user to select one of a plurality of financial cards with which to program the transaction stripe.

5. The portable transaction device of claim 1 further comprising software configured to apply one-time use numbers on to the transaction stripe.

6. The portable transaction device of claim 5 further comprising software for local generation of the one-time use numbers.

7. The portable transaction device of claim 5 further comprising software to download the one-time use numbers via a mobile telephone network.

8. A financial transaction apparatus comprising:
means for interacting with a user to provide a first authentication factor;
means for interacting with a secondary wireless device to provide a second authentication factor; and
means for communicating financial transaction information to a point-of-sale.

9. The financial transaction apparatus of claim 8 wherein the means for interacting with a user comprises a biometric input device.

10. The financial transaction apparatus of claim 9 wherein the biometric input device comprises a fingerprint scanner.

11. The financial transaction apparatus of claim 8 wherein the means for communicating financial transaction information comprises a reprogrammable stripe.

12. The financial transaction apparatus of claim 11 wherein the reprogrammable stripe comprises a programmable magnetic stripe.

13. The financial transaction apparatus of claim 11 wherein the reprogrammable stripe comprises an electronically programmable stripe.

14. The financial transaction apparatus of claim 11 wherein the reprogrammable stripe comprises a smartcard interface.

15. A financial transaction authentication system comprising:
a reprogrammable card having a programmable transaction stripe that may be operatively engaged with a point-of-sale stripe reader; and
a secondary wireless device to provide user authentication, wherein both the reprogrammable card and secondary wireless device are configured to communicate with a portable transaction device.

16. The financial transaction authentication system of claim 15 further comprising the portable transaction device.

17. The financial transaction authentication system of claim 15 wherein the programmable transaction stripe comprises a programmable magnetic stripe.

18. The financial transaction authentication system of claim 15 wherein the programmable transaction stripe comprises an electronically programmable stripe.

19. The financial transaction authentication system of claim 15 wherein the programmable transaction stripe comprises a smartcard interface.

20. The financial transaction authentication system of claim 15 wherein the secondary wireless device comprises a key fob.
